(19) United States
(12) Patent Application Publication
(10) Pub. No.: US 2020/0122094 A1
(43) Pub. Date: Apr. 23, 2020

(54) CURED EPOXYSILICONE LAYER MEMBRANE FOR NANOFILTRATION

(71) Applicant: IMPERIAL COLLEGE INNOVATIONS LIMITED, London (GB)

(72) Inventors: Marcus Cook, London (GB); Andrew Guy Livingston, London (GB)

(21) Appl. No.: 16/627,847

(22) PCT Filed: Jul. 5, 2018
(86) PCT No.: PCT/GB2018/051917

§ 371 Date: Dec. 31, 2019

(30) Foreign Application Priority Data
Jul. 6, 2017 (GB) 1710912.5

(51) Int. Cl. B01D 69/12; B01D 61/02; B01D 71/70; B01D 67/00; B01D 69/02

(52) U.S. Cl. CPC B01D 69/125; B01D 61/027; B01D 71/70; B01D 67/0006; B01D 2323/42; B01D 2325/34; B01D 2325/04; B01D 2323/345; B01D 2323/06; B01D 69/02

(57) ABSTRACT

Processes for the preparation of composite membranes are disclosed, as well as the composite membranes obtainable by these processes. The processes employ a step of roller coating a porous support substrate with an essentially solventless coating mixture containing a cationically UV curable compound, which can then be cured in an oxygen-containing atmosphere. The process thereby dispenses with—or greatly reduces the impact of—a number of the prominent processing constraints of prior art techniques, thereby affording a more streamlined and less energetically burdensome membrane manufacturing process.

### INTRODUCTION

The present invention relates to a process for the preparation of thin film composite membranes, as well as to the thin film composite membranes obtainable by this process and their use in molecular separations. More particularly, the present invention relates to a coating process for the preparation of thin film composite membranes.

### BACKGROUND OF THE INVENTION

Membrane processes are well known in the art of separation science, and can be applied to a range of separations of species of varying molecular weights in liquid and gas phases (see for example “Membrane Technology and Applications” 2^{nd} Edition, R. W. Baker, John Wiley and Sons Ltd, ISBN 0-470-85445-6). Membranes are typically designed with a particular application in mind (e.g. gas separation, reverse osmosis or solvent nanofiltration).

Membranes comprising one or more supporting layers and a separately-formed top separating layer which provides molecular discrimination are described as thin film composite membranes, and are well known in the art. Two principle methods are used to produce these thin film composite membranes, interfacial polymerisation and coating. Baker (ibid) describes a solution coating process involving dipping a support into a solution of polymer in volatile solvent to coat the support with a layer 50-100 microns thick, which is reduced to a thin selective film 0.5-2 microns thick after evaporation of the volatile solvent.

Thin film composite membranes comprising a layer of silicone rubber on top of a support material are well described in the art. U.S. Pat. No. 4,243,701 discloses thin films of dimethylsilicone on various supports, particularly polysulfones, for gas separation. The silicone layer is formed by passing the support through a solution of polymer precursors dissolved in a halogenated hydrocarbon solvent.

Silicone coated thin film composite membranes described in U.S. Pat. No. 5,265,734 are based around thermally crosslinkable silicone polymers, along with pore preservants for the support membrane, and are prepared by coating the support membrane with a dilute solution of silicone pre-polymers in a volatile solvent.

Radiation curable acrylate based silicone polymers have also been used in the preparation of thin film composite membranes.

In spite of the advancements in the prior art, there remains a need for improved processes for the preparation of thin film composite membranes.

The present invention was devised with the foregoing in mind.

### SUMMARY OF THE INVENTION

According to a first aspect of the present invention there is provided a process for the preparation of a composite membrane, the process comprising/consisting essentially of/consisting of the steps of:
a) providing a porous support substrate, the porous support substrate having an upper major surface and a lower major surface;
b) providing a coating mixture comprising:
   i. a photoinitiator, and
   ii. a UV-curable compound bearing one or more groups capable of undergoing cationic UV curing, wherein the coating mixture has a viscosity at 25° C. of 10-1000 cP and comprises less than 50% by weight of a solvent relative to the total weight of the coating mixture, and wherein the photoinitiator and the UV-curable compound are such that the coating mixture is cationically curable upon exposure to UV radiation;
c) applying a film of the coating mixture to the upper major surface of the porous support substrate to provide an uncured membrane assembly;
d) subjecting the uncured membrane assembly to UV radiation in an oxygen-containing atmosphere to cause the film of coating mixture to cure;
   wherein in step c), the coating mixture is transferred from the surface of a rotating first roller to the upper major surface of the porous support substrate.

According to a second aspect of the present invention there is provided a composite membrane obtainable, obtained or directly obtained by the process of the first aspect of the invention.

According to a third aspect of the present invention there is provided a composite membrane comprising:
a porous support substrate having an upper major surface and a lower major surface, and
a polymeric separating layer disposed on the upper major surface of the porous support substrate and in contact therewith,
   wherein the polymeric separating layer comprises the polymerisation product of:
i. a photoinitiator, and
ii. a cationically UV-curable compound, and wherein the mass of polymeric separating layer is less than 10 g per square metre of the porous support substrate.

According to a fourth aspect of the present invention there is provided a use of a membrane according to the second or third aspect of the invention for performing a molecular separation.

According to a fourth aspect of the present invention there is provided a molecular separation process, comprising the steps of:
i. providing a molecular mixture comprising a plurality of first molecules and a plurality of second molecules, the first molecules being different from the second molecules, and
ii. contacting the molecular mixture with a composite membrane according to the second or third aspect of the invention to separate the first molecules from the second molecules.

### DETAILED DESCRIPTION OF THE INVENTION

### Membrane Preparation Process

As described hereinbefore, the present invention provides a process for the preparation of a composite membrane, the process comprising the steps of:
a) providing a porous support substrate, the porous support substrate having an upper major surface and a lower major surface;
b) providing a coating mixture comprising:
   i. a photoinitiator, and
   ii. a UV-curable compound bearing one or more groups capable of undergoing cationic UV curing,
wherein the coating mixture has a viscosity at 25° C. of 10-1000 cP and comprises less than 50% by weight of a solvent relative to the total weight of the coating mixture,
and wherein the photoinitiator and the UV-curable compound are such that the coating mixture is cationically curable upon exposure to UV radiation;
c) applying a film of the coating mixture to the upper major surface of the porous support substrate to provide an uncured membrane assembly;
d) subjecting the uncured membrane assembly to UV radiation in an oxygen-containing atmosphere to cause the film of coating mixture to cure;
   wherein in step c), the coating mixture is transferred from the surface of a rotating first roller to the upper major surface of the porous support substrate.

Against the backdrop of prior art techniques, the present inventors have now devised an improved process for the preparation of thin film composite membrane, offering a number of industrially-relevant advantages. Through extensive studies, the inventors have developed a composite membrane preparation process that dispenses with—or greatly reduces the impact of—a number of prominent processing constraints of prior art techniques, thereby affording a more streamlined and less energetically burdensome process that is better suited to large scale industrial manufacture. In the present process, a support membrane is roller-coated with an essentially solventless (or sparingly solvent-containing) coating mixture, which can then be straightforwardly cured by UV radiation under ambient conditions (e.g. in air at room temperature) to yield a composite membrane. The process offers numerous industrial advantages, including a reduced dependency on the use of organic solvents, the disposal of which carries numerous environmental considerations. Moreover, not only do industrial coating techniques employing large quantities of organic solvents require dedicated in-line drying equipment, they carry the risk that the delicate structure of the formed composite membranes will be irreparably damaged when the solvent is removed by thermal means. Elsewhere, the use of a cationically-polymerisable coating mixture vastly simplifies the UV curing step, which can be performed in air at ambient temperature, and does not therefore carry the processing constraints of coating mixtures that require an inert atmosphere curing blanket to be integrated into the production line. The roller-coated nature of the present process—which can be implemented as part of a continuous production line in an industrial setting—allows those advantages discussed above to be realised to an greater extent.

Composite membranes will be familiar to one of ordinary skill in the art, and comprise an ultra-thin “skin” separating layer disposed over a thicker highly porous mechically supporting layer of a different material.

In an embodiment, the process is for the preparation of a composite membrane having a porous support substrate and a separating layer being in direct contact with the upper surface of the porous support substrate. It will be understood that the film applied in step c), once cured, forms the separating layer of the composite membrane. The separating layer will be understood to be the portion of the membrane that is responsible for effecting the molecular separation for which the membrane was designed (e.g. organic solvent nanofiltration).

In an embodiment, the film applied in step c), once cured, forms the upper surface of the resulting composite membrane (i.e. no other continuous layers are applied on the surface of the cured film).

In an embodiment, the process is for the preparation of a composite membrane that is suitable for performing nanofiltration in an organic solvent feed stream. The organic solvent may be, for example, toluene or TH F. Alternatively, the organic solvent may be a polar aprotic solvent, such as dimethyl formamide or N-methyl-2-pyrrolidone.

In an embodiment, the porous support substrate is polymeric. Suitably, the polymeric support substrate is insoluble in organic solvents. The organic solvent may be a polar aprotic solvent, such as dimethyl formamide or N-methyl-2-pyrrolidone.

The porous support substrate may have a porosity in the microfiltration or ultrafiltration range.

In an embodiment the porous support substrate is formed from one or more polymers selected from the group consisting of polyacrylonitrile, polyetherimide, polyimide, polyaniline, polyester, polyethylene, polypropylene, polyether ether ketone, polyphenylene sulphide, Ethylene-ChloroTriFluoroEthylene copolymer and crosslinked derivatives thereof. Suitably, the porous support substrate is formed from one or more polymers selected from the group consisting of polyacrylonitrile, polyetherimide, polyimide, polyether ether ketone and crosslinked derivatives thereof. Yet more suitably, the porous support substrate is formed from one or more polymers selected from the group consisting of polyacrylonitrile and crosslinked polyetherimide.

In an embodiment, the porous support substrate is provided on a porous substructure, the porous substructure being in contact with the lower major surface of the porous support substrate. The porous substructure may be a non-woven material.

The coating mixture is cationically curable upon exposure to UV radiation. Cationic UV curing involves the photogeneration of cations, which are capable of initiating a cationic polymerisation mechanism. Cationic UV curing presents a variety of advantages over free radical UV curing technique. Perhaps most notably, cationic UV curing is not hampered by oxygen inhibition, which occurs when the high reactivity of molecular oxygen to radical species formed as part of a free radical UV curing technique gives rise to the formation of peroxide and hydro-peroxide species, which hamper the efficiency of the polymerisation process. Therefore, one key advantage of using a cationically UV curable coating mixture is that the coating mixture can be cured in an oxygen-containing atmosphere (e.g. air), without deleterious effect on the efficiency of the polymerisation process.

In an embodiment, the photoinitiator is miscible in the UV-curable compound of the coating mixture.

In an embodiment, the photoinitiator is a cationic photoinitiator. Suitable cationic photoinitiators include organic salts of non-nucleophilic anions, such as aryl sulfonium salts (Ar₃S⁺X⁻) and aryl iodonium salts (Ar₂I⁺X⁻). The anion (X⁻) may be selected from the group consisting of BF⁴⁻, PF⁶⁻, SbF⁶⁻ and AsF⁶⁻.

In an embodiment, the photoinitiator is an iodonium hexafluoroantimonate salt or an iodonium hexafluorophosphate salt.

The UV-curable compound is the portion of the coating mixture that, when polymerised, forms the separating layer of the composite membrane. Typically, the UV-curable compound constitutes the largest part, by mass, of the coating mixture. Typically, the UV-curable compound is a liquid.

The UV-curable compound bears one or more groups that are capable of undergoing cationic UV curing. Suitably, the one or more groups is an electron rich group. Cationic UV curing results from the attack of a proton on the electron rich group of the UV-curable compound, thereby generating a cation capable of attacking the electron rich group of another UV-curable compound.

In an embodiment, the one or more groups that are capable of undergoing cationic UV curing are selected from the group consisting of epoxy, oxetane, lactone and vinyl ether.

In an embodiment, the one or more groups that are capable of undergoing cationic UV curing is, or comprises, one or more of the following moieties capable of undergoing cationic UV curing:

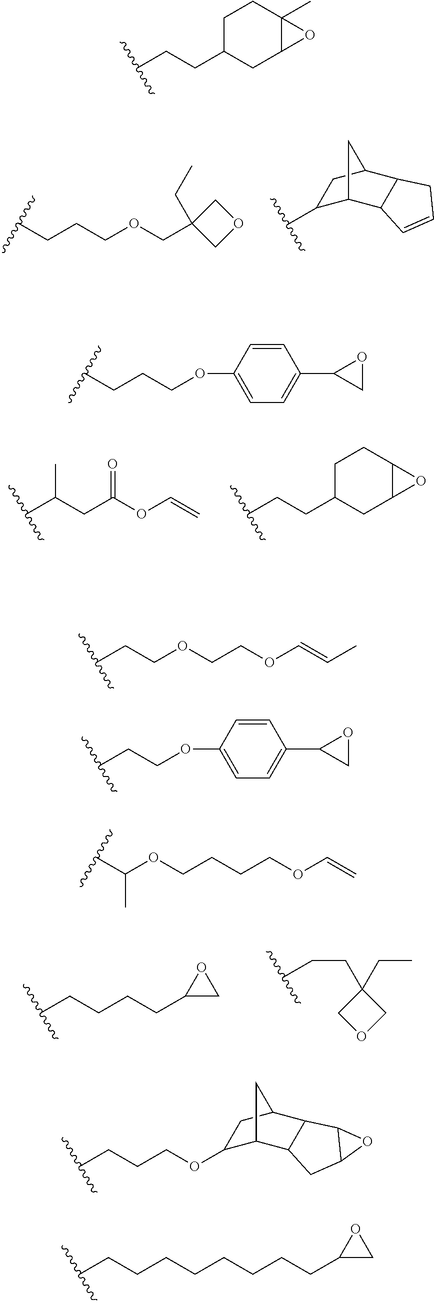

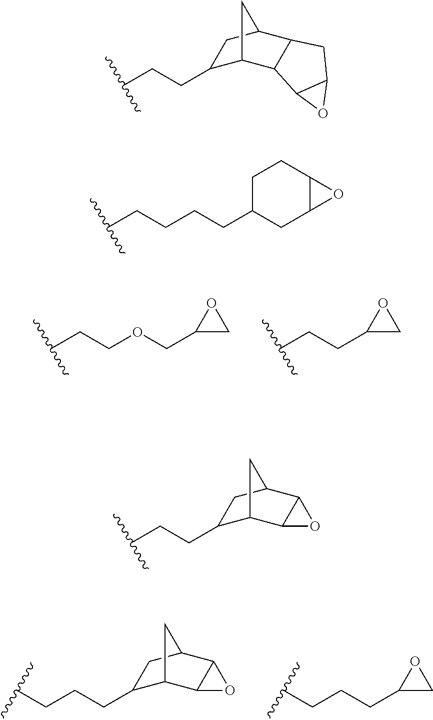

In an embodiment, the UV one or more groups that are capable of undergoing cationic UV curing is, or comprises, one or more of the following moieties capable of undergoing cationic UV curing:

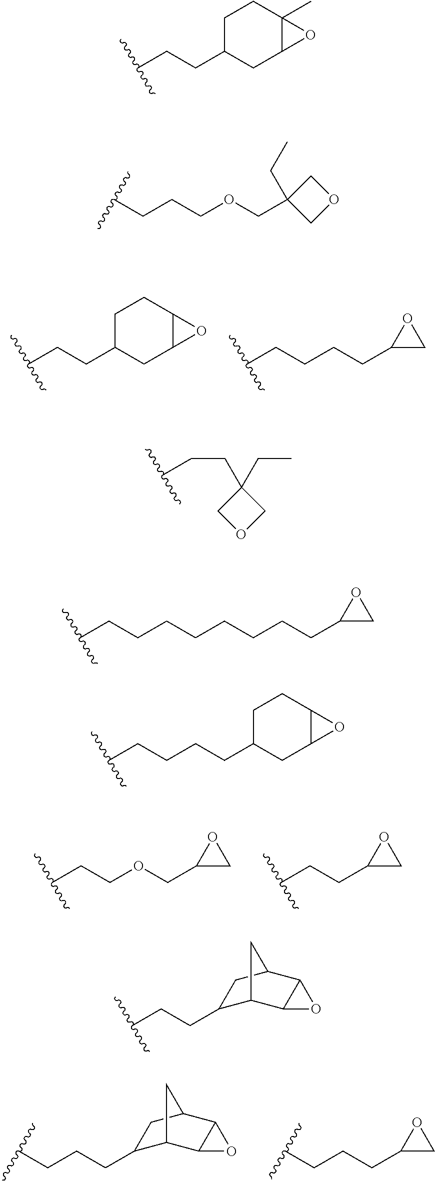

In an embodiment, the one or more groups that are capable of undergoing cationic UV curing is, or comprises, one or more of the following moieties capable of undergoing cationic UV curing:

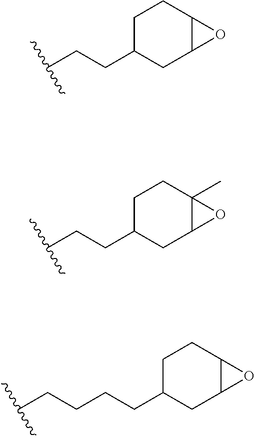 [SMILES: *CCC1CCC2OC2C1 ; *CCC1CCC2(C)OC2C1 ; *CCCCC1CCC2OC2C1]

In an embodiment, the UV-curable compound is a siloxane (also known as a silicone) bearing the one or more groups capable of undergoing cationic UV curing. Suitably the siloxane comprises one or more of the above-outlined moieties capable of undergoing cationic UV curing. The one or more moieties may be attached to the siloxane via a silicon atom.

In an embodiment, the siloxane UV-curable compound is a poly(siloxane) or a cyclic siloxane.

In an embodiment, the UV-curable compound has a structure according to formula (I) shown below:

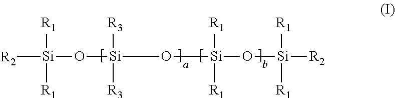

wherein
   each R₁ is independently (1-3C)alkyl,
   each R₂ is independently (1-3C)alkyl or a moiety capable of undergoing cationic UV curing outlined hereinbefore,
   each R₃ is independently (1-3C)alkyl or a moiety capable of undergoing cationic UV curing outlined hereinbefore,
   a ranges from 1 to 100,
   b ranges from 1 to 100,
   with the proviso that at least one R₂ or R₃ is a moiety capable of undergoing cationic UV curing outlined hereinbefore.

It will be understood that when the monomeric units a and b are different, the copolymer of formula (I) is not necessarily a block copolymer. Rather, it will be understood that when the monomeric units a and b are different, they may be arranged in any order along the polymeric backbone, such that the copolymer may be a block, alternating or random copolymer.

In an embodiment, the UV-curable compound has a structure according to formula (I), wherein
each R₁ is independently methyl,
each R₂ is independently methyl or a moiety capable of undergoing cationic UV curing outlined hereinbefore,
each R₃ is independently methyl or a moiety capable of undergoing cationic UV curing outlined hereinbefore,
a ranges from 1 to 25,
b ranges from 1 to 25,
with the proviso that at least one R₂ or R₃ is a moiety capable of undergoing cationic UV curing outlined hereinbefore.

Suitably, the UV-curable compound has a structure according to formula (I), wherein both R₂ are methyl, and one or both R₃ is a moiety capable of undergoing cationic UV curing outlined hereinbefore.

Suitably, the UV-curable compound has a structure according to formula (I), wherein both R₃ are methyl, and one or both R₂ is a moiety capable of undergoing cationic UV curing outlined hereinbefore.

Suitably, in the formula (I), the moiety capable of undergoing cationic UV curing is selected from

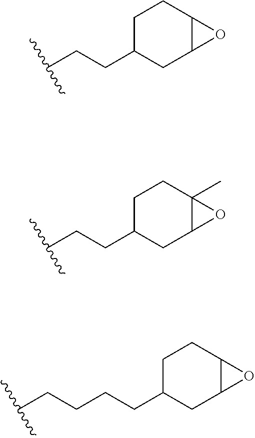 [SMILES: *CCC1CCC2OC2C1 ; *CCC1CCC2(C)OC2C1 ; *CCCCC1CCC2OC2C1]

Suitably, in the formula (I), a and b independently range from 1 to 10.

In an embodiment, the UV-curable compound has the structure A shows below:

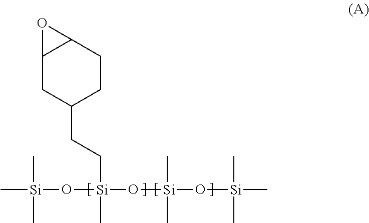

and has a molecular weight of 5000 to 25,000 Da. Suitably the UV-curable compound of structure A has a molecular weight of 8000 to 22,000 Da.

In an embodiment, the UV-curable compound has the structure B shown below:

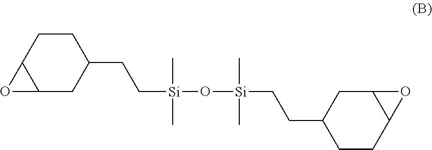 [SMILES: C[Si](C)(CCC1CCC2OC2C1)O[Si](C)(C)CCC1CCC2OC2C1]

In an embodiment, the UV-curable compound is a cyclic siloxane having the structure C shown below:

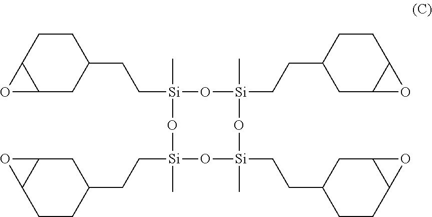 [SMILES: C[Si]1(CCC2CCC3OC3C2)O[Si](C)(CCC2CCC3OC3C2)O[Si](C)(CCC2CCC3OC3C2)O[Si](C)(CCC2CCC3OC3C2)O1]

In an embodiment, the coating mixture comprises two or more of the UV-curable compounds discussed hereinbefore. For example, the coating mixture may comprise UV-curable compounds having the structures A and B outlined above.

In an embodiment, the weight ratio of UV-curable compound to photoinitiator in the coating mixture ranges from 95:5 to 99.99:0.01. Suitably, the weight ratio of UV-curable compound to photoinitiator in the coating mixture ranges from 97:3 to 99.9:0.1. More suitably, the weight ratio of UV-curable compound to photoinitiator in the coating mixture ranges from 98:2 to 99.5:0.5.

The coating mixture has a viscosity at 25° C. of 10-1000 cP. The viscosity of the coating mixture advantageously allows it to be coated onto the porous supporting substrate by a roller apparatus. Suitably, the coating mixture has a viscosity at 25° C. of 100-1000 cP. More suitably, the coating mixture has a viscosity at 25° C. of 200-900 cP. Yet more suitably, the coating mixture has a viscosity at 25° C. of 200-800 cP. Even more suitably, the coating mixture has a viscosity at 25° C. of 200-650 cP. Most suitably, the coating mixture has a viscosity at 25° C. of 200-500 cP.

The solvent that may be present in a quantity of up to 50% by weight relative to the total weight of the coating mixture may be an organic solvent. The present process advantageously allows for a reduced quantity—or essentially no solvent whatsoever—to be used in the coating step, thereby offering the multitude of industrial advantages discussed hereinbefore. Suitably, the coating mixture comprises less than 40% by weight of a solvent relative to the total weight of the coating mixture. More suitably, the coating mixture comprises less than 25% by weight of a solvent relative to the total weight of the coating mixture. Yet more suitably, the coating mixture comprises less than 10% by weight of a solvent relative to the total weight of the coating mixture. Even more suitably, the coating mixture comprises less than 5% by weight of a solvent relative to the total weight of the coating mixture. Even more suitably, the coating mixture comprises less than 2% by weight of a solvent relative to the total weight of the coating mixture. Most suitably, the coating mixture comprises substantially no solvent or no solvent. The membrane preparation process may therefore be substantially or completely solvent-free (e.g. organic solvent-free).

The coating mixture may additionally comprises one or more additives selected from viscosity modifiers, void suppressors, adhesion promoters and surfactants/spreading agents. One or more viscosity modifiers may be present in an amount up to 20% by weight relative to the amount of UV curable compound. One or more void suppressors (e.g. maleic acid) may be present in an amount up to 20% by weight relative to the amount of UV curable compound. One or more adhesion promoters may be present in an amount up to 5% by weight relative to the amount of UV curable compound. Surfactants influence the spreading of the coating mixture, and may be present in the coating mixture at an amount of up to 1% (e.g. up to 0.1%) by weight relative to the amount of UV curable compound.

The coating mixture may also comprise one or more organic or inorganic matrix in the form of a powdered solid. The organic and/or inorganic matrix may be present in an amount of up to 20% by weight relative to the amount of UV curable compound. Carbon molecular sieve matrices can be prepared by pyrolysis of any suitable material as described in U.S. Pat. No. 6,585,802. Graphene or graphene oxide flakes, or 2-D carbon flakes, may also be added to the coating mixture as a matrix. Zeolites as described in U.S. Pat. No. 6,755,900 may also be used as an inorganic matrix. Metal oxides, such as titanium dioxide, zinc oxide and silicon dioxide may be used, for example the materials available from Evonik AG (Germany) under their Aerosol and AdNano trade marks. Mixed metal oxides such as mixtures of cerium, zirconium, and magnesium may be used. Metal organic frameworks and covalent organic framework nanoparticles are also suitable for use. Preferred matrices will be particles less than 1.0 micron in diameter, preferably less than 0.1 microns in diameter, and more preferably less than 0.01 microns in diameter.

Prior to performing coating step c), the coating mixture may be sonicated and/or filtered.

In step c) of the process, the coating mixture is transferred from the surface of a rotating first roller to the upper major surface of the porous support substrate. Step c) encompasses a variety of roller apparatuses known in the art.

In an embodiment, step c) is carried out using a single rotating roller (i.e. the rotating first roller), the surface of which is coated with the coating mixture, which is then transferred onto the upper major surface of the porous support substrate by contact of the upper major surface of the porous support substrate with the coating mixture-coated surface of the rotating first roller. The surface of the rotating first roller may become coated with the coating mixture by passing the surface of the rotating first roller through a bath of the coating mixture prior to the coated surface of the rotating first roller coming into contact with the upper major surface of the porous support substrate. In such embodiments, a portion of the surface of the first rotating roller is in contact with a bath of the coating mixture at the same time that another portion of the surface of the first rotating roller is in contact with the upper major surface of the porous support substrate.

In an embodiment, the surface of the first rotating roller becomes coated with the coating mixture by transferral of the coating mixture from the surface of a second rotating roller to the surface of the first rotating roller. The surface of the second rotating roller may be in direct contact with the source of coating mixture (e.g. a bath), or it may be in indirect contact with the source of coating mixture (e.g. by being in contact with the surface of one or more additional rollers, the surface of the end-most roller being in contact with the source of coating mixture). This arrangement may sometimes be referred to as offset coating.

In an embodiment, during coating of the upper major surface of the porous support substrate, the support substrate may pass between two opposing rollers, the first of which being the first rotating roller, the second (often referred to as an impression roller) being intended to push the porous support substrate onto the surface of the first rotating roller, thereby facilitating transfer of the coating mixture to the upper major surface of the porous support substrate.

In an embodiment, the amount of coating mixture on the surface of the first rotating roller that is to be transferred onto the upper major surface of the porous support substrate is controlled using a doctor blade. The doctor blade may be configured to such that the amount of coating mixture that is transferred to the upper major surface of the porous support substrate is 40-50% of the total capacity of depressions present in the surface of the rotating first roller.

In an embodiment, the surface of the rotating first roller comprises one or more depressions. The depressions may take the form of grooves, dimples, notches and/or furrows. The depressions serve as wells in the surface of the rotating first roller for retaining a quantity of the coating mixture on the surface of the roller as it rotates, in order that the coating mixture can them be transferred onto the upper major surface of the porous support substrate. Suitably, the depressions are distributed across the surface of the rotating first roller.

Step c) may be conducted according to a gravure coating technique.

In an embodiment, the first rotating roller comprises one or more depressions having a total volume of 0.01-100 cm³ per m² of the surface of the rotating first roller. Suitably, the first rotating roller comprises one or more depressions having a total volume of 0.01-50 cm³ per m² of the surface of the rotating first roller. More suitably, the first rotating roller comprises one or more depressions having a total volume of 0.01-10 cm³ per m² of the surface of the rotating first roller. Yet more suitably, the first rotating roller comprises one or more depressions having a total volume of 0.01-5 cm³ per m² of the surface of the rotating first roller. Most suitably, the first rotating roller comprises one or more depressions having a total volume of 0.01-1 cm³ per m² of the surface of the rotating first roller.

In an embodiment, in step c), the quantity of coating mixture applied to the upper major surface of the porous support substrate during step c) is less than 50 g per square metre of the porous support substrate. The process of the invention advantageously allows comparatively thinner films of coating mixture to be coated onto the upper major surface of the supporting substrate. This advantageously results in composite membranes having a thinner—and hence more efficient—separating layer. Suitably, in step c), the quantity of coating mixture applied to the upper major surface of the porous support substrate during step c) is less than 10 g per square metre of the porous support substrate. More suitably, in step c), the quantity of coating mixture applied to the upper major surface of the porous support substrate during step c) is less than 5 g per square metre of the porous support substrate. Even more suitably, in step c), the quantity of coating mixture applied to the upper major surface of the porous support substrate during step c) is less than 1 g per square metre of the porous support substrate. Yet more suitably, in step c), the quantity of coating mixture applied to the upper major surface of the porous support substrate during step c) is less than 0.6 g per square metre of the porous support substrate. Most suitably, in step c), the quantity of coating mixture applied to the upper major surface of the porous support substrate during step c) is less than 0.55 g per square metre of the porous support substrate.

Once the coating mixture has been applied to the upper major surface of the porous support substrate to yield an uncured membrane assembly, step d) involves subjecting the uncured membrane assembly to UV radiation in an oxygen-containing atmosphere to cause the film of coating mixture to cure. During the curing process, the UV curable compound will react according to the cationic mechanism discussed hereinbefore to crosslink individual UV curable compounds together, or to polymerise them into a polymer. The cured film of coating mixture may resemble a polymeric network.

In an embodiment, step d) comprises subjecting the uncured membrane assembly to UV radiation in an oxygen-containing atmosphere for a sufficient amount of time to initiate the curing process. The cationic curing mechanism exploited by the present invention may continue even when the UV source has been removed.

UV radiation will be understood by the skilled person to be that having a wavelength of 10 to 400 nm. A UV lamp may be used in step d). Suitably, the dose of UV radiation delivered during step d) ranges from 10 to 2500 mJ/cm². More suitably, the dose of UV radiation delivered during step d) ranges from 250 to 2500 mJ/cm². Yet more suitably, the dose of UV radiation delivered during step d) ranges from 400 to 2200 mJ/cm². In an embodiment, the dose of UV radiation delivered during step d) ranges from 400 to 600 mJ/cm². In another embodiment, the dose of UV radiation delivered during step d) ranges from 1800 to 2200 mJ/cm².

In an embodiment, step d) is conducted in an atmosphere containing greater than 1 vol % oxygen. The process of the invention advantageously allows to the coating step to be conducted in an oxygen-containing atmosphere (e.g. air), thereby dispensing with the processing constraints of prior art processes (e.g. the need for an inert atmosphere blanket). Suitably, step d) is conducted in an atmosphere containing greater than 10 vol % oxygen. More suitably, step d) is conducted in air.

In an embodiment, after curing step d), the cured membrane assembly may be subjected to an electron beam treatment. Suitably the dose of electron beam radiation is 25-500 kGy (e.g. 50, 75, 100 or 200 kGy). Suitably, the accelerating voltage of the electron beam treatment is 60-300 eV (e.g. 70-90 eV or 140-300 eV).

In an embodiment, the process of the invention is a continuous process. For example, steps a) to d) may be performed in an in-line manner, whereby a continuous web of porous support substrate is roller-coated with the coating mixture and is then conveyed to a downstream UV source for curing. Continuous (as opposed to batch) processes have clear industrial advantages.

In an embodiment, the process of the invention is a continuous process operating at a machine speed of 0.1 to 500 m/min. Suitably, the process of the invention is a continuous process operating at a machine speed of 0.5 to 50 m/min.

### Composite Membranes

As described hereinbefore, the present invention provides a composite membrane obtainable, obtained or directly obtained by the process of the first aspect of the invention.

The present invention also provides a composite membrane comprising:
a porous support substrate having an upper major surface and a lower major surface, and
a polymeric separating layer disposed on the upper major surface of the porous
support substrate and in contact therewith,
   wherein the polymeric separating layer comprises the polymerisation product of:
i. a photoinitiator, and
ii. a cationically UV-curable compound,
   and wherein the mass of polymeric separating layer is less than 10 g per square metre of the porous support substrate.

The composite membranes of the invention present a number of advantages over membranes made by conventional techniques. For example, the membrane preparation process discussed hereinbefore allows for the preparation of composite membranes having a notably reduced coat weight (per unit surface area of the porous support substrate) of separating layer. Composite membranes having a reduced coat weight of separating layer may be more efficient at performing the molecular separation for which they were intended (e.g. organic solvent nanofiltration), since an excessive coating of separating layer will have a detrimental effect on the overall permeance (e.g. flux) of the composite membrane.

In the context of the second and third aspects of the invention, the porous support substrate, cationically UV-curable compound and photoinitiator may have any of the definitions discussed hereinbefore in respect of the first aspect of the invention.

In an embodiment, the porous support substrate is provided on a porous substructure, the porous substructure being in contact with the lower major surface of the porous support substrate. The porous substructure may be a non-woven material.

In an embodiment, the mass of polymeric separating layer is less than 5 g per square metre of the porous support substrate. Suitably, the mass of polymeric separating layer is less than 1 g per square metre of the porous support substrate. More suitably, the mass of polymeric separating layer is less than 0.6 g per square metre of the porous support substrate. Most suitably, the mass of polymeric separating layer is less than 0.55 g per square metre of the porous support substrate.

In an embodiment, the membrane has a molecular weight cut-off (MWCO) in the region of 200-5000 g mol⁻¹. The molecular weight cut-off of a membrane is generally defined as the molecular weight of a molecule that would exhibit a rejection of 90% when subjected to separation by the membrane. Suitably, the membrane has a molecular weight cut-off (MWCO) in the region of 200-1000 g mol⁻¹. More suitably, the membrane has a molecular weight cut-off (MWCO) in the region of 200-800 g mol⁻¹. Membranes have MWCO in this region may be termed nanofiltration membranes.

In an embodiment, the membrane has a toluene flux of 3-100 m²h⁻¹bar⁻¹. Alternatively, the membrane has a toluene flux of 3-60 m²h⁻¹bar⁻¹. Alternatively, the membrane has a toluene flux of 5-50 m²h⁻¹ bar⁻¹. Alternatively, the membrane has a toluene flux of 5-40 m²h⁻¹bar⁻¹. Alternatively, the membrane has a toluene flux of 20-40 m²h⁻¹bar⁻¹.

In an embodiment, the membrane may be configured in accordance with any of the designs known to those skilled in the art, such as spiral wound, plate and frame, shell and tube, and derivative designs thereof.

### Membrane Applications

As described hereinbefore, the present invention provides a use of a membrane according to the second or third aspect of the invention for performing a molecular separation.

In an embodiment, the molecular separation is a nanofiltration process. Nanofiltration describes a membrane process whereby solute molecules (typically of molecular weight 200-5000 g mol⁻¹) are separated from solvents and some smaller solutes, when a pressure gradient is applied across the membrane. This may be defined in terms of membrane rejection Rᵢ, a common measure known by those skilled in the art and defined as:

$${R}_{i} = ( 1 - \frac{{C}_{Pi}}{{C}_{Ri}} ) \times 100 \% \qquad ( 1 )$$

where C_{P,i}=concentration of species i in the permeate, permeate being the liquid which has passed through the membrane, and C_{R,i}=concentration of species i in the retentate, retentate being the liquid which has not passed through the membrane. It will be appreciated that a membrane is selectively permeable for a species i if Rᵢ>0. It is well understood by those skilled in the art that nanofiltration is a process in which at least one solute molecule i with a typical molecular weight in the range 200-5,000 g mol⁻¹ is retained at the surface of the membrane over at least one solvent, so that Rᵢ>0. Typical applied pressures in nanofiltration range from 5 bar to 50 bar.

In an embodiment of the nanofiltration process, the solvent (from which a solute is separated) may be an organic or aqueous liquid having a molecular weight at least 20 g mol⁻¹ less than that of the solute to be separated. The solvent may, for example, have a molecular weight of less than 300 g mol⁻¹. Alternatively, the solvent may have a molecular weight of less than 200 g mol⁻¹. Non-limiting examples of solvents include aromatics, alkanes, ketones, glycols, chlorinated solvents, esters, ethers, amines, nitriles, aldehydes, phenols, amides, carboxylic acids, alcohols, furans, and dipolar aprotic solvents, water, and mixtures thereof. Non-limiting specific examples of solvents include toluene, xylene, benzene, styrene, anisole, chlorobenzene, dichlorobenzene, chloroform, dichloromethane, dichloroethane, methyl acetate, ethyl acetate, butyl acetate, methyl ether ketone (MEK), methyl isobutyl ketone (MIBK), acetone, ethylene glycols, ethanol, methanol, propanol, butanol, hexane, cyclohexane, dimethoxyethane, methyl tert-butyl ether (MTBE), diethyl ether, adiponitrile, N,N-dimethylformamide, dimethylsulfoxide, N,N-dimethylacetamide, dioxane, nitromethane, nitrobenzene, pyridine, carbon disulfide, tetrahydrofuran, methyltetrahydrofuran, N-methyl pyrrolidone, acetonitrile, water, and mixtures thereof.

In an embodiment of the nanofiltration process, the solvent is a polar apotic solvent.

In an embodiment of the nanofiltration process, the solute (which is separated from the solvent) is an organic molecule having a molecular weight at least 20 g mol⁻¹ greater than that of the solvent.

In an embodiment of the nanofiltration process, the weight fraction of the solute in the liquid to be nanofiltrated is less than the weight fraction of the solvent.

### EXAMPLES

One or more examples of the invention will now be described, for the purpose of illustration only, with reference to the accompanying figures, in which:

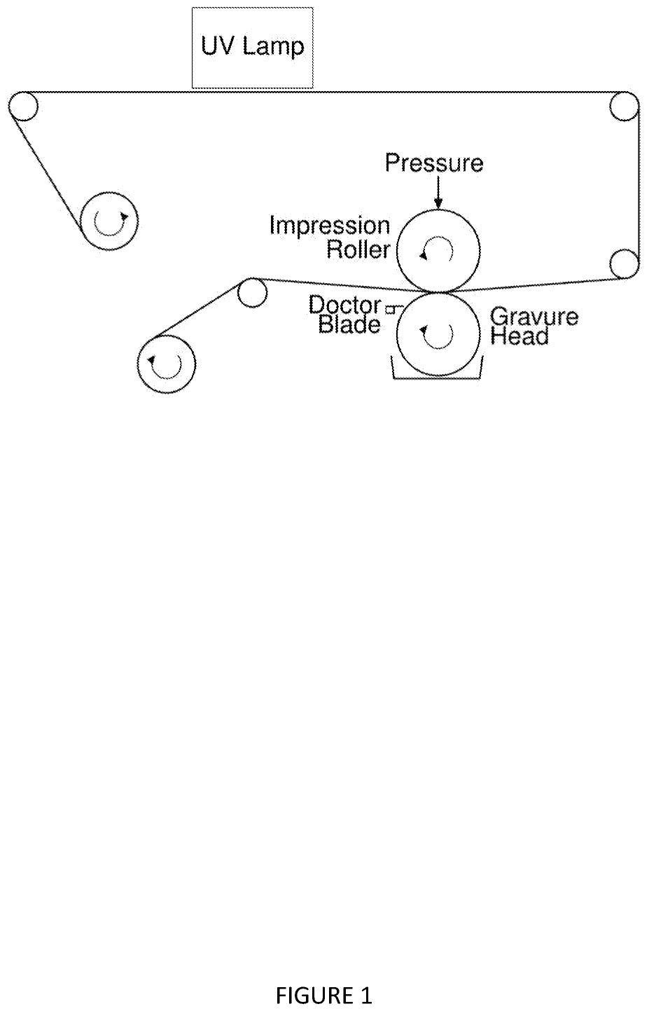

FIG. 1 shows a schematic of a gravure coating process.

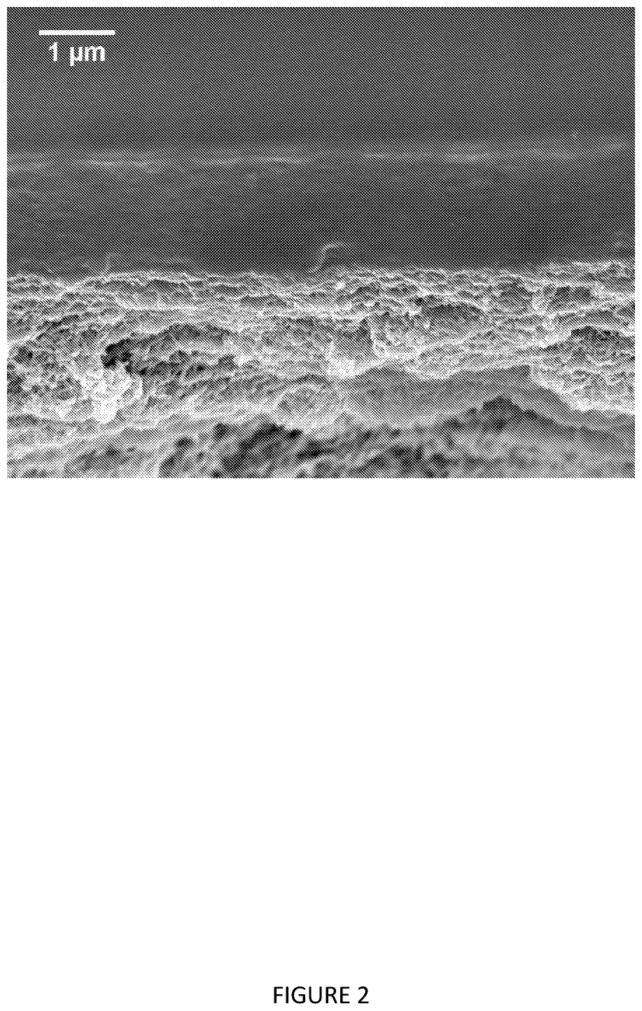

FIG. 2 shows a silicone coated membrane of Example 5 with nominal thickness of 1.5 micron.

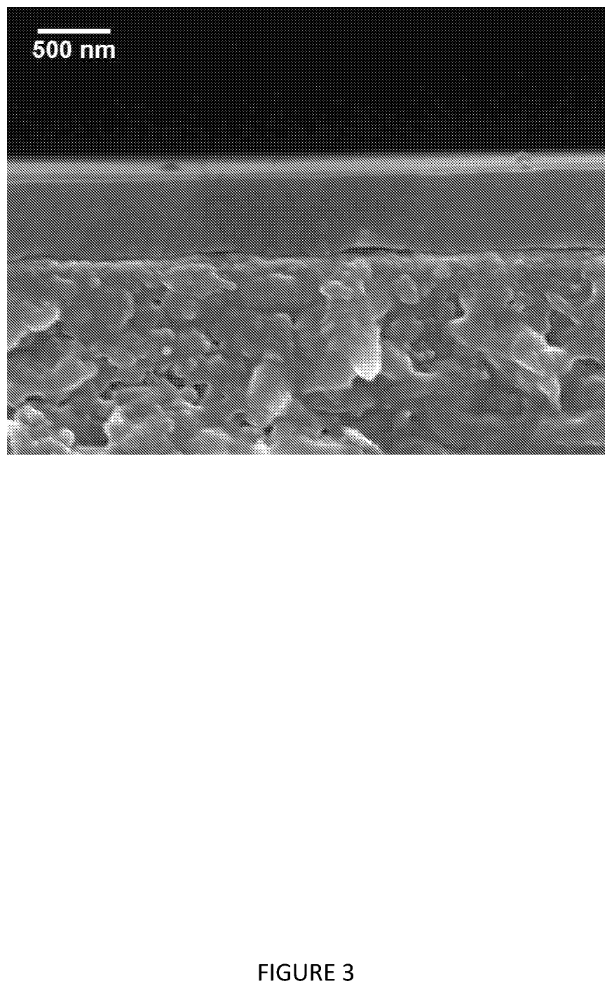

FIG. 3 shows a silicone coated membrane of Example 3 with nominal thickness below 0.5 micron.

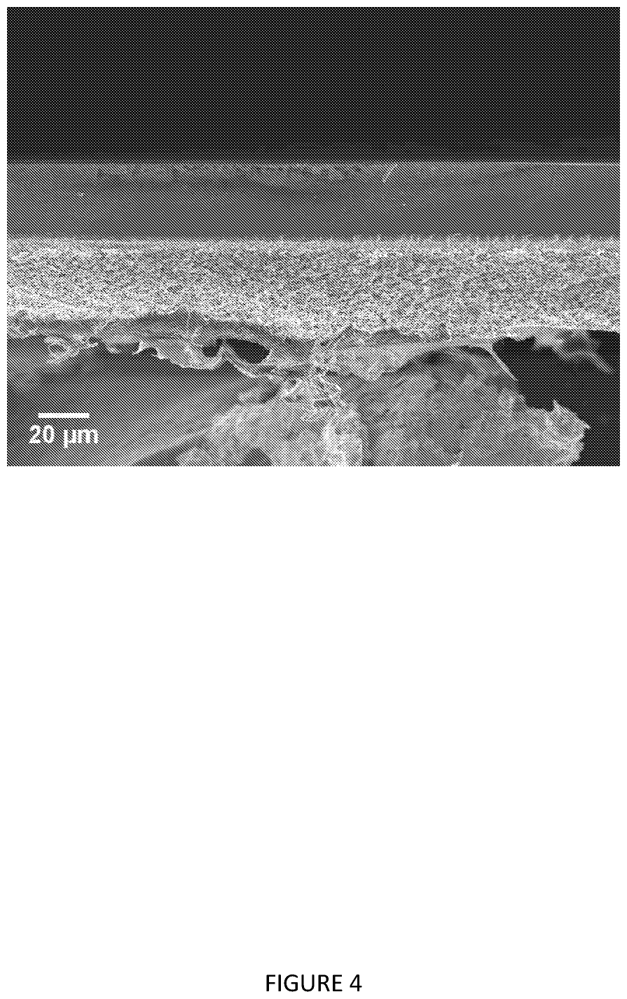

FIG. 4 shows a silicone coated membrane of Example 11 with coat weight of 25 g m⁻².

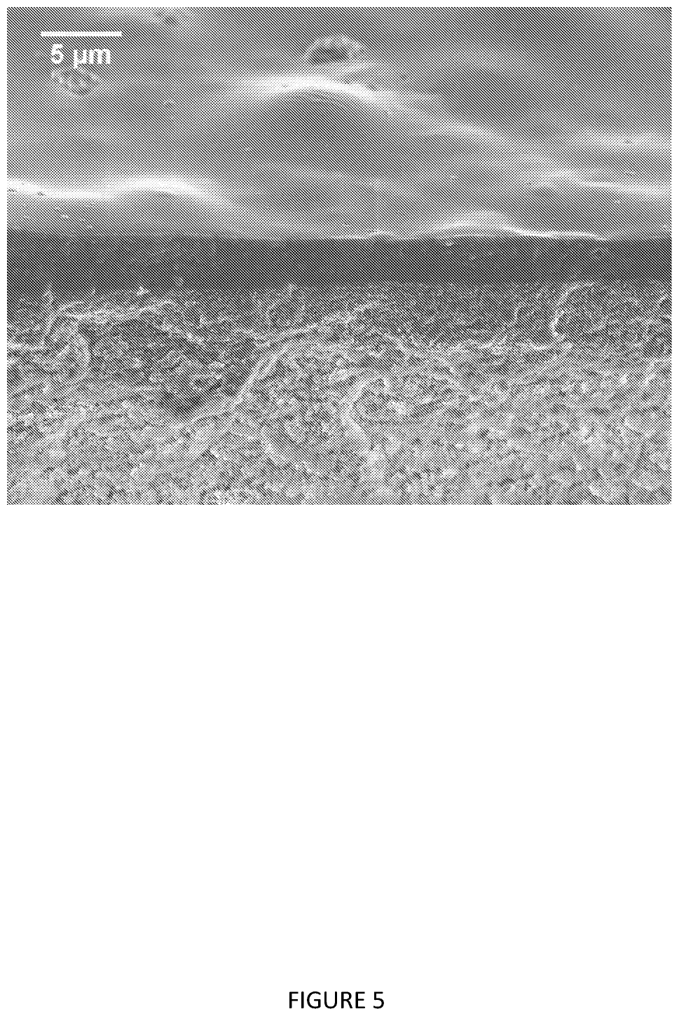

FIG. 5 shows a silicone coated membrane of Example 6.

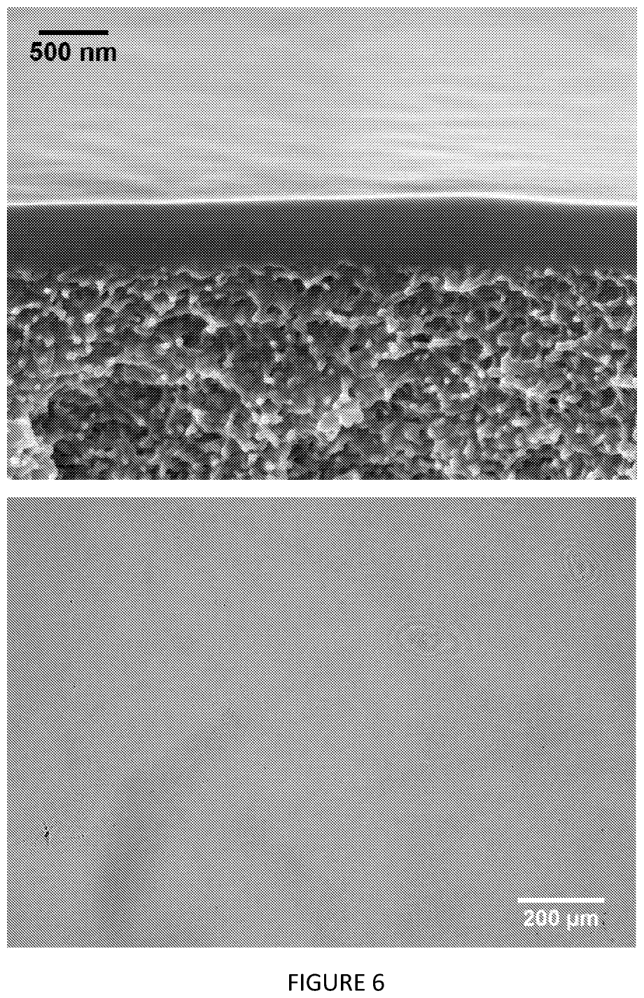

FIG. 6 shows a cross section image of the composite membrane prepared in Example 10 (top), with a corresponding light microscope image (bottom).

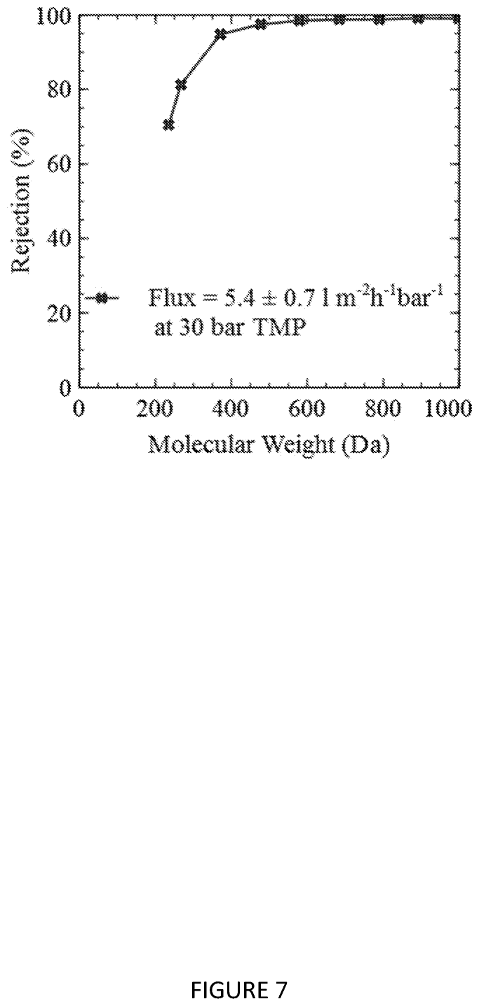

FIG. 7 shows the MWCO curve and heptane flux of the composite membrane described in Example 5.

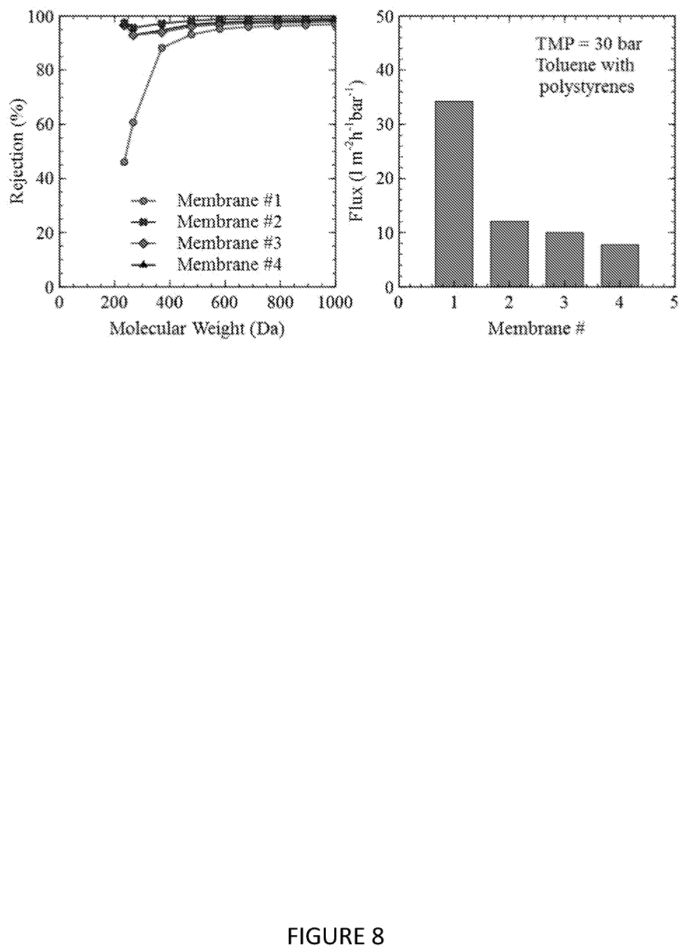

FIG. 8 shows the MWCO curve and toluene flux of composite membranes prepared in Example 7 that were further subjected to electron beam radiation.

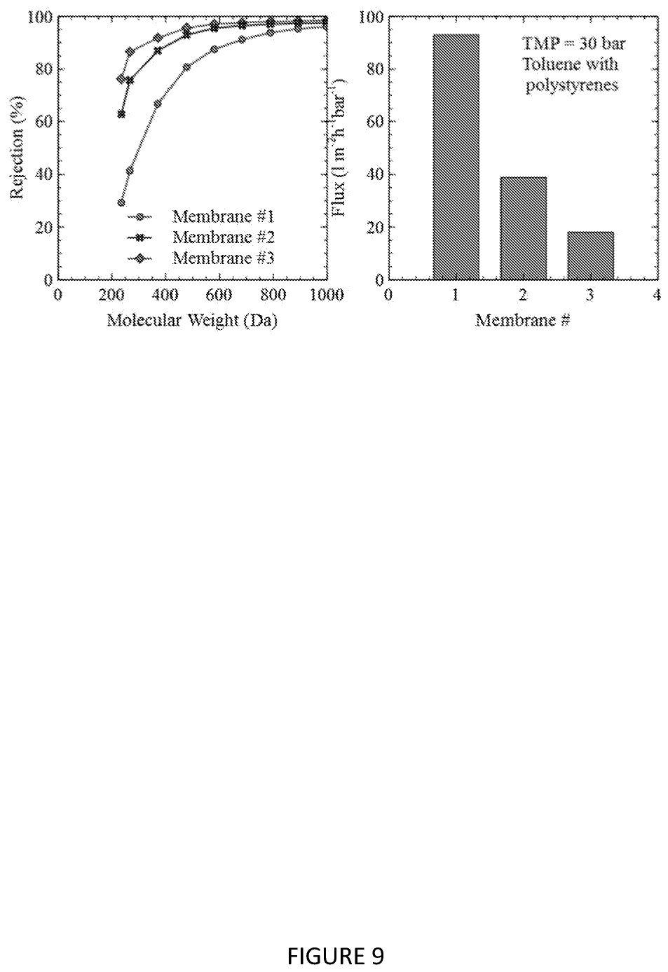

FIG. 9 shows the MWCO curve and toluene flux of composite membranes prepared in Example 9 that were further subjected to electron beam radiation.

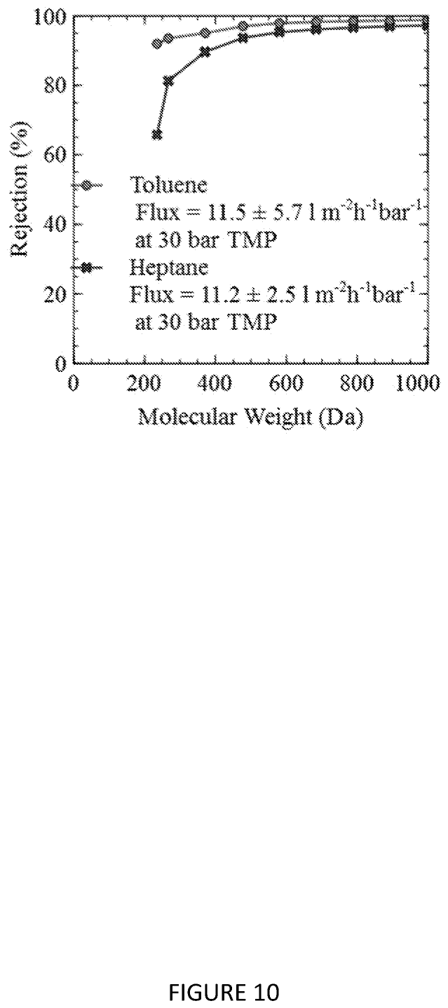

FIG. 10 shows the MWCO curves in toluene and heptane of a composite membrane prepared in Example 10.

### MATERIALS AND METHODS

### Materials

The following materials were used in the examples:

Ultem 1000 is a polyetherimide (Sabic)
Polyacrylonitrile (230 k) was obtained from Goodfellow
ECMS-924 is an [8-10% (epoxycyclohexylethyl)methylsiloxane]-dimethylsiloxane copolymer having a viscosity of 300-450 cSt (Gelest)
ECMS-327 is an [3-4% (epoxycyclohexylethyl)methylsiloxane]-dimethylsiloxane copolymer having a viscosity of 650-850 cSt (Gelest)
Speedcure 937 is an iodonium hexafluoroantimonate salt (Lambson Limited)
Omnicat 445 is a iodonium hexafluorophosphate salt (IGM Resins)
1,3-bis(3,4-epoxycyclohexyl-1-ethyl)tetramethyldisiloxane (Gelest)

### SEM Measurements

Membrane samples were freeze fractured and analysed by a high resolution scanning electron microscope (SEM), LEO 1525, Karl Zeiss.

### Membrane MWCO and Flux

Flux and rejection measurements were used to characterise the performance of the fabricated membranes of the present invention. A laboratory scale cross-flow nanofiltration unit was used with 8 cross flow cells in series. Membrane discs of active area 14 cm² were used. A 2 L feed tank was charged with a feed solution consisting of 1 g of styrene oligomers of nominal molecular weight 580 g mol⁻¹ and 1 g of styrene oligomers of nominal molecular weight 1000 g mol⁻¹ (Agilent) and 0.1 g of α-methylstyrene dimer (Sigma Aldrich, UK). The styrene oligomers were all fully soluble in the tested solvents at this concentration and the feed solution was re-circulated at a flow rate of 120 L h⁻¹ using a diaphragm pump (Hydra-Cell, Wanner, USA). Pressure in the cells was generated using a backpressure regulator which was located downstream of a pressure gauge. The re-circulating liquid was kept at 30° C. by a heat exchanger. During operation, permeate samples were collected from individual sampling ports for each cross-flow cell and the retentate sample was taken from the feed tank. The solvent flux Nᵥ was calculated from the equation:

$${N}_{v} = \frac{V}{At} \qquad ( 1 )$$

where V=volume of a liquid sample collected from the permeate stream from a specific cross-flow cell, t=time over which the liquid sample is collected, A=membrane area. Polystyrene rejection was measured using an Agilent HPLC machine. A reverse phase column (C18-300, 250 mm×4.6 mm, ACE Hichrom) was used and the mobile phases were 10% THF and 90% MeOH. The HPLC pump flow rate was set at 1 ml min⁻1 and the column temperature was set at 30° C. The rejection, Rᵢ, was calculated via the following equation:

$${R}_{i} = ( 1 - \frac{{c}_{p , i}}{{c}_{f , i}} ) \times 100 \qquad ( 2 )$$

where c_{p,i} is the concentration of solute in permeate, and c_{f,i} is the concentration of solute in the feed.

Testing was confined to either n-heptane or toluene with the polystyrenes as described above. Prior to HPLC analysis, a solvent swap was conducted of the polystyrenes to acetonitrile through evaporation of test solvent. In additional cases, diphenylanthracene (330 Da) was used as a solute at levels of up to 50 ppm in toluene or heptane within the same experimental set up, except that UV-Vis was used to analyze the concentration, with the rejection being calculated by Equation 2.

### Example 1—Preparation of PAN Support Membrane

A polyacrylonitrile (PAN) ultrafiltration membrane was prepared by creating a polymer solution of PAN:DMSO:1,3 dioxolane at a mass ratio of 22:89:89. This mixture was heated overnight at 75° C. Upon cooling the polymer solution was subject to two filtration steps (firstly 41 micron filter, and subsequently an 11 micron filter) through a nitrogen pressurised filtration cell (Merck Millipore, XX4004740) at pressures of up to 70 psi. The resultant polymer solution appeared free of particulates and had a viscosity of 20,000 cP. The membrane was cast on to a PET non woven backing material on a continuous casting machine so that the cast polymer film was subject to 30 seconds of atmospheric exposure prior to immersion into a water bath. The membrane was then dried. The membrane exhibited a mean flow pore size in the range of 18-25 nm with a pure heptane permeance of several hundred I m⁻² h⁻¹ bar⁻¹ as characterised by liquid liquid porometry (Porolux 1000).

### Example 2—Preparation of Crosslinked PEI Support Membrane

A solvent stable ultrafiltration membrane from Ultem 1000 polyetherimide was prepared by dissolving the Ultem 1000 in a 50:50 mixture of DMSO:1,4 Dioxane at 15 wt %. The powder dissolved readily and was cast on to a PET non-woven backing on a continuous casting machine at 8 metres/minute. The dope and nonwoven were immersed in water, and then transferred to IPA. The ultrafiltration membrane was then placed into a reactor vessel with 10 litre capacity, and propanediamine was added to the vessel at 0.5 wt %. The vessel was then heated to 60° C. by means of a heated jacket and left for 4 hours. The crosslinked membrane was then cooled and washed with IPA, and further dried. The membrane remained flexible in the dry state, and exhibited a mean flow pore size similar to that of the PAN membrane described in Example 1. The degree of crosslinking as measured by FTIR through the conversion of imide to amide groups was around 50%.

### Example 3—Gravure Coating on PAN Support Membrane

An epoxysilicone co polymer (ECMS-924, Gelest), characterised with 8-10 mol % epoxy was mixed with an antimonate based photoinitiator (Speedcure 937, Lamsbon chemicals) at a ratio of 99:1 polymer:initiator. After thorough mixing, this solution was filtered through a 0.65 μm DVPP filter (Merck Millipore), subsequently sonicated and subjected to vacuum filtration ready for coating. The solution viscosity was 400 cP. A PAN ultrafiltration membrane described in Example 1 was wound into a pilot scale coating machine (RK Print, UK) that contained a gravure coating cylinder (1,900 Ipi with a nominal volume capacity of 1 cm³ m⁻²) and a UV lamp (GEW, UK). The gravure coating head was operated in the forward configuration with the use of an impression roller (40 degree EPDM rubber) at 40 psi. The web was run through the machine such that the active side of the UF membrane was in contact with the gravure cylinder as it passed through the nip point at a speed of 4 m/min, and then immediately passed through a UV lamp employing a dosage to the substrate >500 mJ/cm². The resultant film appeared tack free after leaving the UV lamp. A typical cross section SEM image of this membrane can be seen in FIG. 3.

### Example 4—Gravure Coating on Crosslinked PEI Support Membrane

The epoxysilicone coating mixture described in Example 3 was coated on to the crosslinked Ultem 1000 substrate via similar machine conditions. The intensity of the UV lamp was increased, such that the dose was this time >2,000 mJ/cm² to render the coated film somewhat tack free.

### Example 5—Gravure Coating on PAN Support Membrane

The procedure described in Example 3 was repeated, except that a gravure head engraved at 400 Ipi was utilised, with a nominal volume capacity of 5 cm³ m⁻².

An SEM image of the membrane is shown in FIG. 2, and the corresponding membrane performance in heptane with polystyrenes is shown in FIG. 7.

### Example 6—Blend Coating on PAN Support Membrane

A blend of epoxysilicone co-polymers (ECMS-924:ECMS-327) was prepared at a mass ratio of 6:4, and mixed with the antimonate based photoinitiator (Speedcure 937) at the same ratio as described previously (99:1). The resultant solution appeared more cloudy than that described in Example 3 and exhibited a viscosity of 600 cP. This formulation was coated on to the PAN substrate following the methodology described in Example 3, except that a gravure head engraved at 400 Ipi was utilised, with a nominal volume capacity of 5 cm³ m⁻². With a single pass through the UV lamp, the resultant film appeared tack free. A cross section SEM image of this membrane can be seen in FIG. 5.

### Example 7—Blend Coating on PAN Support Membrane

An epoxysilicone co polymer (ECMS-924) was mixed with an epoxysilicone monomer (1,3-bis(3,4-epoxycyclohexyl-1-ethyl)tetramethyldisiloxane, Gelest) at a ratio of 8:2 polymer:monomer, and mixed with the antimonate based photoinitiator (Speedcure 937) at the same ratio as described previously (99:1). The resultant solution exhibited a viscosity of 250 cP. This formulation was coated on to the PAN substrate following the same methodology in Example 3. With a single pass through the UV lamp, the resultant film appeared tack free. The composite membrane was characterised by the fact that there was a higher level of intrusion as measured by SEM-EDS of the silicone coating into the support membrane than in previous examples.

Some membrane sheets from this coating run were additionally exposed to electron beam radiation (EB lab system, ebeam technologies, USA). Details of the applied dosage are given in the following table:

TABLE 1
Different electron beam treatments applied to Example 7
composite membranes

| Membrane # | Dose (kGy) | Accelerating Voltage (eV) |
|---|---|---|
| 1 | n/a | n/a |
| 2 | 50 | 80 |
| 3 | 75 | 80 |
| 4 | 100 | 80 |

The MWCO curve of these membranes in toluene is shown in FIG. 8.

### Example 8—Gravure Coating Under Heating

Example 3 was repeated, except this time prior to coating, the solution and coating head were heated to 80° C. in an oven. Upon removal from the oven, the coating process was quickly conducted to minimise heat losses. At the elevated temperature that this coating was conducted, the viscosity of the same formulation described in Example 3 is roughly half.

### Example 9—Gravure Coating on Crosslinked PEI Support Membrane

A commercially available epoxysilicone coating solution (Silicolease UV Poly 205, Bluestar silicones) was coated on to the crosslinked Ultem 1000 substrate via the same methodology given in Example 3, with the UV lamp intensity set such that the applied dosage on the substrate >2,000 mJ/cm². Some membrane sheets from this coating run were additionally exposed to electron beam radiation (EB lab system, ebeam technologies, USA). Details of the applied dosage are given in the following table:

TABLE 2
Different electron beam treatments applied to Example 9
composite membranes

| Membrane # | Dose (kGy) | Accelerating Voltage (eV) |
|---|---|---|
| 1 | n/a | n/a |
| 2 | 100 | 80 |
| 3 | 200 | 80 |

The MWCO curve of these membranes in toluene is shown in FIG. 9

### Example 10—Gravure Coating on PAN Support Membrane

To compare, the commercially available epoxysilicone coating solution (Silicolease UV Poly 205, Bluestar silicones) utilised in Example 9 was also coated on to PAN substrate via the same methodology given in Example 3. The resultant membrane had a silicon active layer of around 500 nm as verified by SEM in FIG. 6. Light microscopy revealed that the coating had spread uniformly and contained a minimal amount of defects. The MWCO curves of this membrane in heptane and in toluene is given in FIG. 10.

### Example 11—Gravure Coating on PAN Support Membrane

A repeat coating was conducted via the same procedure as described in Example 3, except that a gravure head engraved at 55 Ipi was utilised, with a nominal volume capacity of 50 cm³ m⁻². An SEM image of the membrane is shown in FIG. 4, which had <0.1 I m⁻² h⁻¹ bar⁻¹ permeance for either toluene or heptane.

While specific embodiments of the invention have been described herein for the purpose of reference and illustration, various modifications will be apparent to a person skilled in the art without departing from the scope of the invention as defined by the appended claims.

1. A process for the preparation of a composite membrane, the process comprising the steps of:
a) providing a porous support substrate, the porous support substrate having an upper major surface and a lower major surface;
b) providing a coating mixture comprising:
i. a photoinitiator, and
ii. a UV-curable compound bearing one or more groups capable of undergoing cationic UV curing,
wherein the coating mixture has a viscosity at 25° C. of 10-1000 cP and comprises less than 50% by weight of a solvent relative to the total weight of the coating mixture, and
and wherein the photoinitiator and the UV-curable compound are such that the coating mixture is cationically curable upon exposure to UV radiation;
c) applying a film of the coating mixture to the upper major surface of the porous support substrate to provide an uncured membrane assembly;
d) subjecting the uncured membrane assembly to UV radiation in an oxygen-containing atmosphere to cause the film of coating mixture to cure;
wherein in step c), the coating mixture is transferred from the surface of a rotating first roller to the upper major surface of the porous support substrate.

2. The process of claim 1, wherein the porous support substrate is polymeric.

3. The process of claim 1 or 2, wherein the porous support substrate is formed from one or more polymers selected from the group consisting of polyacrylonitrile, polyetherimide, polyimide, polyaniline, polyester, polyethylene, polypropylene, polyether ether ketone, polyphenylene sulphide, Ethylene-ChloroTriFluoroEthylene copolymer and crosslinked derivatives thereof.

4. The process of any one of claim 1, 2 or 3, wherein the porous support substrate is formed from one or more polymers selected from the group consisting of polyacrylonitrile, polyetherimide, polyimide, polyether ether ketone and crosslinked derivatives thereof.

5. The process of any preceding claim, wherein the porous support substrate is provided on a porous substructure, the porous substructure being in contact with the lower major surface of the porous support substrate.

6. The process of claim 5, wherein the porous substructure is a non-woven material.

7. The process of any preceding claim, wherein the photoinitiator is a cationic photoinitiator.

8. The process of any preceding claim, wherein the photoinitiator is an organic salt of a non-nucleophilic anion.

9. The process of claim 8, wherein the anion is selected from the group consisting of BF⁴⁻, PF⁶⁻, SbF⁶⁻ and AsF⁶⁻.

10. The process of claim 8 or 9, wherein the organic salt is a diaryliodonium salt.

11. The process of any preceding claim, wherein the one or more groups capable of undergoing cationic UV curing are selected from the group consisting of epoxy, oxetane, lactone and vinyl ether.

12. The process of any preceding claim, wherein the one or more groups that are capable of undergoing cationic UV curing is, or comprises, any one or more or the following moieties:

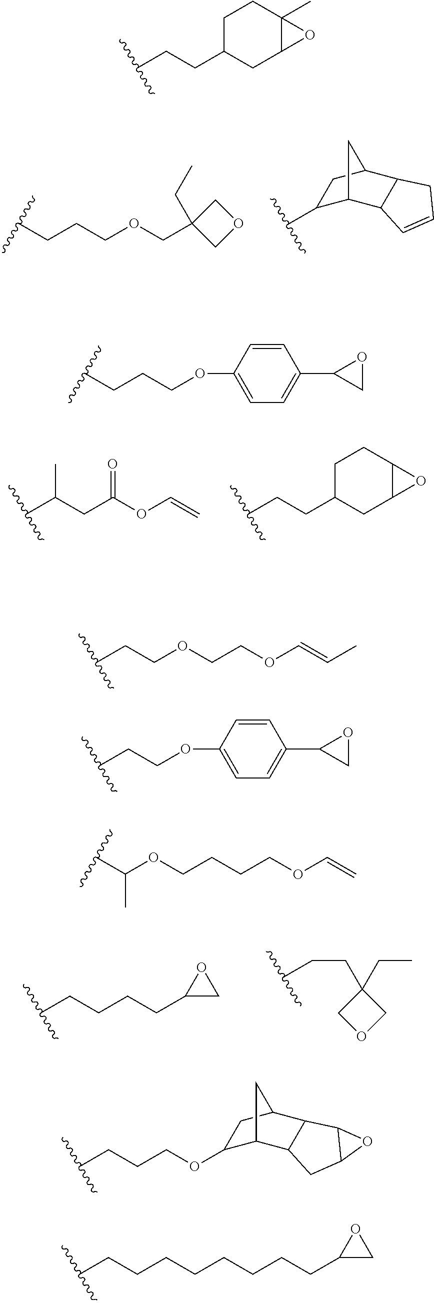

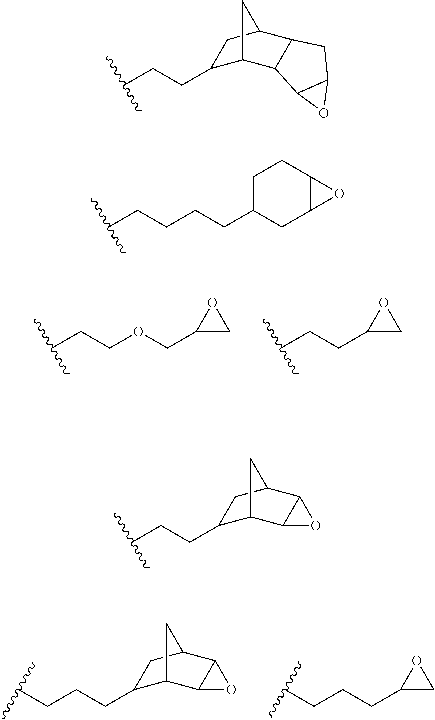

13. The process of any preceding claim, wherein the UV-curable compound is a siloxane bearing the one or more groups capable of undergoing cationic UV curing.

14. The process of claim 13, wherein the siloxane is a poly(siloxane) or a cyclic siloxane.

15. The process of any preceding claim, wherein the UV-curable compound has a structure according to formula (I) shown below: 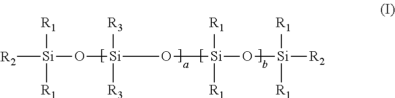
wherein
each R₁ is independently (1-3C)alkyl,
each R₂ is independently (1-3C)alkyl or a moiety capable of undergoing cationic UV curing as defined in claim 12,
each R₃ is independently (1-3C)alkyl or a moiety capable of undergoing cationic UV curing as defined in claim 12,
a ranges from 1 to 100,
b ranges from 1 to 100,
with the proviso that at least one R₂ or R₃ is a moiety capable of undergoing cationic UV curing as defined in claim 12.

16. The process of any preceding claim, wherein the UV-curable compound is one or more compounds selected from:

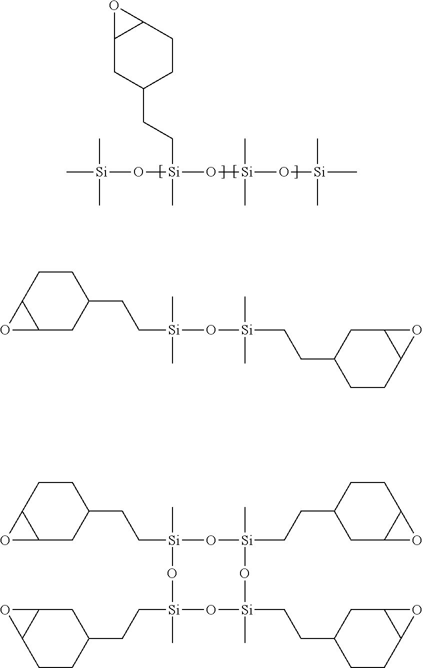

17. The process of any preceding claim, wherein the weight ratio of UV-curable compound to photoinitiator in the coating mixture ranges from 95:5 to 99.99:0.01.

18. The process of any preceding claim, wherein coating mixture has a viscosity at 25° C. of 10-800 cP.

19. The process of any preceding claim, wherein coating mixture has a viscosity at 25° C. of 25-650 cP.

20. The process of any preceding claim, wherein coating mixture has a viscosity at 25° C. of 25-400 cP.

21. The process of any preceding claim, wherein the solvent that may be present in the coating mixture is an organic solvent.

22. The process of any preceding claim, wherein the coating mixture comprises less than 40% by weight of a solvent relative to the total weight of the coating mixture.

23. The process of any preceding claim, wherein the coating mixture comprises less than 25% by weight of a solvent relative to the total weight of the coating mixture.

24. The process of any preceding claim, wherein the coating mixture comprises less than 10% by weight of a solvent relative to the total weight of the coating mixture.

25. The process of any preceding claim, wherein the coating mixture comprises less than 5% by weight of a solvent relative to the total weight of the coating mixture.

26. The process of any preceding claim, wherein the coating mixture comprises substantially no solvent or no solvent.

27. The process of any preceding claim, wherein the surface of the rotating first roller comprises one or more depressions (e.g. grooves, dimples, notches or furrows).

28. The process of claim 27, wherein the one or more depressions have a total volume of 0.01-100 cm³ per m² of the surface of the rotating first roller.

29. The process of any preceding claim, wherein during step c) at least a portion of the surface of the rotating first roller is in constant contact with a quantity of the coating mixture contained within a reservoir.

30. The process of any preceding claim, wherein the quantity of coating mixture applied to the upper major surface of the porous support substrate is metered using a doctor blade or a second roller.

31. The process of any preceding claim, wherein the quantity of coating mixture applied to the upper major surface of the porous support substrate during step c) is less than 50 g per square metre of the porous support substrate.

32. The process of any preceding claim, wherein the quantity of coating mixture applied to the upper major surface of the porous support substrate during step c) is less than 10 g per square metre of the porous support substrate.

33. The process of any preceding claim, wherein the quantity of coating mixture applied to the upper major surface of the porous support substrate during step c) is less than 1 g per square metre of the porous support substrate.

34. The process of any preceding claim, wherein the quantity of coating mixture applied to the upper major surface of the porous support substrate during step c) is less than 0.60 g per square metre of the porous support substrate.

35. The process of any preceding claim, wherein the quantity of coating mixture applied to the upper major surface of the porous support substrate during step c) is less than 0.55 g per square metre of the porous support substrate.

36. The process of any preceding claim, wherein step d) is conducted in an atmosphere containing greater than 1 vol % oxygen.

37. The process of any preceding claim, wherein step d) is conducted in an atmosphere containing greater than 10 vol % oxygen.

38. The process of any preceding claim, wherein step d) is conducted in air.

39. The process of any preceding claim, wherein the cured composite membrane resulting from step d) is subjected to electron beam treatment.

40. The process of any preceding claim, wherein the process is a continuous process.

41. A composite membrane obtainable, obtained or directly obtained by the process of any preceding claim.

42. A composite membrane comprising:
a porous support substrate having an upper major surface and a lower major surface, and
a polymeric separating layer disposed on the upper major surface of the porous support substrate and in contact therewith,
wherein the polymeric separating layer comprises the polymerisation product of:
i. a photoinitiator, and
ii. a cationically UV-curable compound,
and wherein the mass of polymeric separating layer is less than 10 g per square metre of the porous support substrate.

43. The composite membrane of claim 42, wherein the porous support is as defined in any one of claims 1-40.

44. The composite membrane of claim 42 or 43, wherein the photoinitiator is as defined in any one of claims 1-40.

45. The composite membrane of claim 42, 43 or 44, wherein the cationically UV-curable compound is as defined in any one of claims 1-40.

46. The composite membrane of any one of claims 42 to 45, wherein the mass of polymeric separating layer is less than 0.55 g per square metre of the porous support substrate.

47. The composite membrane of any one of claims 42 to 46, wherein the membrane has a molecular weight cut-off (MWCO) in the region of 200-5000 g mol⁻¹.

48. Use of a composite membrane as claimed in any one of claims 41 to 47 for performing a molecular separation process.

49. The use of claim 48, wherein the molecular separation process is a nanofiltration process.
